(19) United States
(12) Patent Application Publication
(10) Pub. No.: US 2025/0158546 A1
(43) Pub. Date: May 15, 2025

(54) TECHNIQUE FOR CONTROLLING MOTOR IN ELECTRIC WORK MACHINE

(71) Applicant: MAKITA CORPORATION, Anjo-shi (JP)

(72) Inventors: Masatoshi ITO, Anjo-shi (JP); Masatoshi SHINODA, Anjo-shi (JP)

(73) Assignee: MAKITA CORPORATION, Anjo-shi (JP)

(21) Appl. No.: 18/946,449

(22) Filed: Nov. 13, 2024

(30) Foreign Application Priority Data
Nov. 15, 2023 (JP) 2023-194485

(51) Int. Cl. H02P 6/24; A01D 34/47; A01D 34/58; H02P 6/08; H02P 6/30

(52) U.S. Cl. CPC H02P 6/24; H02P 6/085; H02P 6/30; A01D 34/47; A01D 34/58

(57) ABSTRACT

In one aspect of the present disclosure, an electric work machine includes a motor, a first manual switch, a second manual switch, and a control circuit. The control circuit executes a drive control, a first stop control, and a second stop control. The first stop control includes stopping the motor, based on the motor being rotated and the first manual switch having received the first stop operation. The second stop control includes stopping the motor, based on the motor being rotated and the second manual switch having received the second stop operation. The second stop control is different from the first stop control.

### CROSS-REFERENCE TO RELATED APPLICATIONS

This application claims the benefit of Japanese Patent Application No. 2023-194485 filed on Nov. 15, 2023, with the Japan Patent Office, the disclosure of which is incorporated herein by reference.

### BACKGROUND

The present disclosure relates to a technique for controlling a motor in an electric work machine.

Japanese Patent No. 5351752 discloses a brush cutter including a trigger switch. In this brush cutter, a user turns ON a trigger switch, so that a motor rotates. If the trigger switch is turned OFF during rotation of the motor, a specific control to stop the motor (hereinafter, referred to as “stop control”) is performed.

### SUMMARY

Depending on a state of the brush cutter at the time of starting a stop control, user's usability may be reduced when the stop control has performed. The same applies to various electric work machines other than the brush cutter.

In one aspect of the present disclosure, it is desirable to provide an electric work machine that can increase usability provided when its motor is decelerated or stopped.

One aspect of the present disclosure provides an electric work machine including a motor, a first manual switch, a second manual switch, and a control circuit.

The first manual switch is configured to alternatively receive a first drive operation or a first stop operation. The second manual switch is configured to alternatively receive a second drive operation or a second stop operation. The first drive operation, the first stop operation, the second drive operation, and the second stop operation are manually performed by a user of the electric work machine.

The control circuit executes a drive control. The drive control includes rotating the motor, based on (i) the first manual switch receiving the first drive operation and (ii) the second manual switch receiving the second drive operation.

The control circuit executes a first stop control. The first stop control includes stopping the motor, based on (i) the motor being rotated and (ii) the first manual switch having received the first stop operation.

The control circuit executes a second stop control. The second stop control includes stopping the motor, based on (i) the motor being rotated and (ii) the second manual switch having received the second stop operation. The second stop control is different from the first stop control.

The electric work machine configured as described above allows the user to decelerate (and thus, stop) the motor by performing the first stop operation on the first manual switch and/or the second stop operation on the second manual switch. Moreover, the first stop control based on the first stop operation is different from the second stop control based on the second stop operation. This enables the user to selectively use the first stop operation or the second stop operation in accordance with, for example, operations or use conditions of the electric work machine when the motor is decelerated or stopped. This makes it possible to provide an electric work machine that can improve usability provided when the motor is decelerated or stopped.

### BRIEF DESCRIPTION OF THE DRAWINGS

An example embodiment of the present disclosure will be described hereinafter by way of example with reference to the accompanying drawings, in which:

FIG. 1 is a perspective view of an electric work machine in an embodiment;

FIG. 2 is a perspective view of a right grip and a manipulation unit;

FIG. 3 is an explanatory diagram of an operation panel;

FIG. 4 is a side view of the right grip and the manipulation unit;

FIG. 5 is an explanatory diagram illustrating an electrical configuration of the electric work machine;

FIG. 6 is an explanatory diagram illustrating various states of the electric work machine in accordance with a position of the second manual switch; and

FIG. 7 is an explanatory diagram illustrating processes executed by a control circuit.

### DETAILED DESCRIPTION OF EXEMPLARY EMBODIMENTS

### 1. Overview of Embodiment

One embodiment may provide an electric work machine including at least any one of the following Features 1 to 18.
Feature 1: a motor.
Feature 2: a first manual switch (or first manipulator).
Feature 3: the first manual switch is configured to alternatively receive (or receive, or selectively receive) a first drive operation or a first stop operation.
Feature 4: the first drive operation and the first stop operation are manually performed by a user of the electric work machine. The first drive operation may correspond to commanding to rotate the motor. The first stop operation may correspond to commanding to decelerate and/or stop the motor.
Feature 5: a second manual switch (or second manipulator).
Feature 6: the second manual switch is configured to alternatively receive (or receive, or selectively receive) a second drive operation or a second stop operation.
Feature 7: the second drive operation and the second stop operation are manually performed by the user. The second drive operation may correspond to commanding to rotate the motor. The second stop operation may correspond to commanding to decelerate and/or stop the motor.
Feature 8: a control circuit.
Feature 9: the control circuit is configured to execute (or perform) a drive control (or drive operation).
Feature 10: the drive control includes rotating the motor.
Feature 11: the drive control includes rotating the motor, based on (i) the first manual switch receiving the first drive operation and (ii) the second manual switch receiving the second drive operation.
Feature 12: the control circuit is configured to execute (or perform) a first stop control (or first stop operation).
Feature 13: the first stop control includes stopping the motor.
Feature 14: the first stop control includes stopping the motor, based on (i) the motor being rotated and (ii) the first manual switch having received the first stop operation. The motor being rotated may include the motor being rotated based on the drive control.
Feature 15: the control circuit is configured to execute (or perform) a second stop control (or second stop operation).
Feature 16: the second stop control includes stopping the motor.
Feature 17: the second stop control is different from the first stop control.
Feature 18: the second stop control includes stopping the motor, based on (i) the motor being rotated and (ii) the second manual switch having received the second stop operation. The motor being rotated may include the motor being rotated based on the drive control.

The second manual switch may be independent from the first manual switch. In other words, the first manual switch and the second manual switch may be individually provided. Compared with the first stop control, the second stop control may differ in (i) a time period from a start of an execution to a stop of the motor, (i) a deceleration from the start of the execution to the stop of the motor (for example, a time-series change and/or a mean value), and/or (iii) an application pattern of a braking force from the start of the execution to the stop of the motor (for example, an application time point and/or a magnitude of the braking force).

The electric work machine may include a drive circuit. The drive circuit may be electrically coupled to the control circuit and the motor. The drive circuit may be configured to receive a motor control signal from the control circuit directly or through an intermediate circuit. The motor control signal is generated by the control circuit, in order to drive or stop the motor (in other words, control the motor). The drive circuit may be configured to supply an electric power to the motor or stop the supply of the electric power to the motor, in accordance with the motor control signal. The motor may receive the electric power from the drive circuit and thereby rotate. The intermediate circuit may include a gate circuit. The gate circuit may be configured to receive the motor control signal. The gate circuit may be configured to output the motor control signal to the drive circuit. The gate circuit may be configured to output, to the drive circuit, a motor drive signal corresponding to the motor control signal. In this case, the drive circuit may be configured to supply the electric power to the motor or to stop the supply of the electric power for the motor, in accordance with the motor drive signal.

The electric work machine including at least Features 1 to 18 can improve usability provided when the motor is decelerated or stopped.

In addition to or in lieu of at least any one of the above-described Features 1 to 18, one embodiment may include at least any one of the following Features 19 to 23.
Feature 19: the first stop control includes decelerating the motor at a first mean deceleration (or a first deceleration) and thereby stopping the motor, based on (i) the motor being rotated and (ii) the first manual switch having received the first stop operation
Feature 20: the first mean deceleration is a mean value of decelerations (or is a deceleration) of the motor during a period from a time the first manual switch receives the first stop operation until the motor stops.
Feature 21: the second stop control includes decelerating the motor at a second mean deceleration (or a second deceleration) and thereby stopping the motor, based on (i) the motor being rotated and (ii) the second manual switch having received the second stop operation.
Feature 22: the second mean deceleration is a mean value of decelerations (or is a deceleration) of the motor during a period from a time the second manual switch receives the second stop operation until the motor stops.
Feature 23: the second mean deceleration is different from the first mean deceleration.

The motor being rotated may include the motor being rotated by the drive control.

For example, it is assumed that there is a state of rotating the motor at a specific rotational speed. In this state, a time period needed to stop the motor when the first stop operation is performed is different from the time period needed to stop the motor when the second stop operation is performed.

The first mean deceleration may correspond to, for example, a value obtained by dividing a first start speed by a first stop required time. The first start speed may be a rotational speed of the motor when the first stop operation is performed (or the first stop control is started). The first stop required time may be a time period from when the first stop operation is performed (or the first stop control is started) until when the motor stops.

The second mean deceleration may correspond to, for example, a value by dividing a second start speed by a second stop required time. The second start speed may be the rotational speed of the motor when the second stop operation is performed (or the second stop control is started). The second stop required time may be a time period from when the second stop operation is performed (or the second stop control is started) until when the motor stops.

The decelerations of the motor from when the first stop operation is performed until when the motor stops may (i) vary in any manner or (ii) be constant. The same applies to the deceleration from when the second stop operation is performed until when the motor stops.

The electric work machine including at least Features 1 to 23 allows the user to select a degree of deceleration to be applied when the motor is decelerated or stopped.

In addition to or in lieu of at least any one of the above-described Features 1 to 23, one embodiment may include the following one.
Feature 24: the first mean deceleration is smaller than the second mean deceleration.

The electric work machine including at least Features 1 to 24 may provide the user with the following use mode. For example, the following describes a case of (i) temporarily stopping the drive control and (ii) subsequently executing the drive control again before the motor stops. In this case, the user may perform the first stop operation on the first manual switch, and thereby the first stop control may be executed. Alternatively, if the motor is to be immediately to stop, the user may perform the second stop operation on the second manual switch, and thereby the second stop control may be executed.

In addition to or in lieu of at least any one of the above-described Features 1 to 24, one embodiment may include the following Feature 25 and/or 26.
Feature 25: the first stop control includes decelerating the motor at a first initial mean deceleration during a first deceleration period, based on (i) the motor being rotated and (ii) the first manual switch having received the first stop operation. The first deceleration period may be a period of time until elapse of a first deceleration time period from when the first stop operation is performed (or the first stop control is started). The first initial mean deceleration is a mean value of decelerations of the motor during the first deceleration period.
Feature 26: the second stop control includes decelerating the motor at a second initial mean deceleration during a second deceleration period, based on (i) the motor being rotated and (ii) the second manual switch having received the second stop operation. The second deceleration period may be a period of time until elapse of a second deceleration time from when the second stop operation is performed (or the second stop control is started). The second initial mean deceleration is a mean value of decelerations of the motor during the second deceleration period. The second initial mean deceleration is different from the first initial mean deceleration.

The first deceleration time is shorter than a time period from when the first stop operation is performed until when the motor stops. The second deceleration time is shorter than a time period from when the second stop operation is performed until when the motor stops. In other words, the motor still rotates at the time of elapse of the first deceleration time from when the first stop operation is performed. The motor still rotates at the time of elapse of the second deceleration time from when the second stop operation is performed.

The first initial mean deceleration may be smaller than the second initial mean deceleration.

In addition to or in lieu of at least any one of the above-described Features 1 to 26, one embodiment may include at least any one of the following Features 27 to 31.
Feature 27: the first stop control includes rotating the motor by inertia until elapse of a first period of time from a time the first manual switch receives the first stop operation.
Feature 28: the first stop control includes applying a braking force to the motor and thereby decelerating the motor, based on the elapse of the first period of time from the time the first manual switch receives the first stop operation.
Feature 29: the second stop control includes rotating the motor by inertia until elapse of a second period of time from a time the second manual switch receives the second stop operation.
Feature 30: the second period of time is shorter than the first period of time.
Feature 31: the second stop control includes applying a braking force to the motor and thereby decelerating the motor, based on the elapse of the second period of time from the time the second manual switch receives the second stop operation.

The electric work machine including at least Features 1 to 18 and 27 to 31 enables desired first and second stop controls to be easily achieved by having a difference in time period of rotation by inertia.

In one embodiment, in both of the first stop control and the second stop control, the braking force may be applied to the motor without rotation of the motor by inertia. In this case, a first braking force in the first stop control may be smaller than a second braking force in the second stop control.

In a case in which one embodiment includes Feature 27 and/or 28, the second stop control may apply the braking force to the motor without rotation of the motor by inertia.

In one embodiment, the first stop control may allow the motor to keep rotating by inertia without applying a braking force to the motor, thereby stopping the motor. In this case, the second stop control may apply a braking force to the motor after the motor is rotated by inertia for a specified period of time.

In addition to or in lieu of at least any one of the above-described Features 1 to 31, one embodiment may include at least any one of the following Features 32 to 34.
Feature 32: the second stop control includes stopping the motor in accordance with a control profile. The control profile may be configured to stop the motor.
Feature 33: the control profile is based on a first actual speed (or actual speed in operation).
Feature 34: the first actual speed is an actual rotational speed of the motor at a time the second manual switch receives the second stop operation.

The control profile is a procedure (in other words, a process, a process procedure, a control procedure, a control system, or a control operation, or a control content) predetermined for stopping the motor, which is executed by the control circuit during a period from when the second stop operation is performed until when the motor stops. In a case in which the second stop operation is performed on the electric work machine as described above, a degree of the decelerations of the motor can vary depending on the first actual speed.

In addition to or in lieu of at least any one of the above-described Features 1 to 34, one embodiment may include at least any one of the following Feature 35 to 38.
Feature 35: the control profile is configured such that a second mean deceleration in a first state is greater than the second mean deceleration in a second state.
Feature 36: the second mean deceleration is a mean value of decelerations of the motor during a period from the time the second manual switch receives the second stop operation until the motor stops.
Feature 37: the first state corresponds to a state in which the first actual speed is less than a threshold speed.
Feature 38: the second state corresponds to a state in which the first actual speed is greater than or equal to the threshold speed.

In a case in which the second stop operation is performed on the electric work machine including at least Features 1 to 18 and 32 to 38, a degree of deceleration of the motor can vary depending on whether the first actual speed is greater than or equal to the threshold speed.

In addition to or in lieu of at least any one of the above-described Features 1 to 38, one embodiment may include the following Feature 39 and/or 40.
Feature 39: the control profile includes decelerating the motor at a third initial mean deceleration during a second deceleration period, in a case in which the first actual speed is greater than or equal to a threshold speed. The second deceleration period may be a period of time until elapse of a second deceleration time period from a time the second stop operation is performed (or the second stop control is started). The third initial mean deceleration is a mean value of decelerations of the motor during the second deceleration period.
Feature 40: the control profile includes decelerating the motor at a fourth initial mean deceleration during the second deceleration period, in a case in which the first actual speed is less than the threshold speed. The fourth initial mean deceleration is a mean value of decelerations of the motor during the second deceleration period. The fourth initial mean deceleration is greater than the third initial mean deceleration.

The second deceleration time is shorter than a time period from when the second stop operation is performed until when the motor stops. In other words, the motor still rotates when the second deceleration time elapses from the time the second stop operation is performed.

In addition to or in lieu of at least any one of the above-described Features 1 to 40, one embodiment may include at least any one of the following Features 41 to 43.
Feature 41: the control profile includes rotating the motor by inertia until elapse of a specified period of time from the time the second manual switch receives the second stop operation, based on the first actual speed being greater than or equal to the threshold speed.
Feature 42: the control profile includes applying a braking force to the motor and thereby decelerating the motor, based on (i) the first actual speed being greater than or equal to the threshold speed and (ii) the elapse of the specified period of time from the time the second manual switch receives the second stop operation.
Feature 43: the control profile includes applying a braking force to the motor without rotating the motor by inertia and thereby decelerating the motor, based on the first actual speed being less than the threshold speed.

Feature 42 may be rephrased as applying a braking force to the motor and thereby decelerating the motor after the elapse of the specified period of time.

The specified period of time may be the same as the second period of time.

The electric work machine including at least Features 1 to 18 and 32 to 43 enables a degree of the deceleration of the motor to be easily changed in accordance with the first actual speed.

In addition to or in lieu of at least any one of the above-described Features 1 to 43, one embodiment may include at least any one of the following Features 44 to 48.
Feature 44: the control profile includes rotating the motor by inertia until elapse of a first specified period of time from the time the second manual switch receives the second stop operation, based on the first actual speed being greater than or equal to the threshold speed.
Feature 45: the control profile includes applying a braking force to the motor and thereby decelerating the motor, based on (i) the first actual speed being greater than or equal to the threshold speed and (ii) the elapse of the first specified period of time from the time the second manual switch receives the second stop operation.
Feature 46: the control profile includes rotating the motor by inertia until elapse of a second specified period of time from the time the second manual switch receives the second stop operation, based on the first actual speed being less than the threshold speed.
Feature 47: the control profile includes applying a braking force to the motor and thereby decelerating the motor, based on (i) the first actual speed being less than the threshold speed and (ii) the elapse of the second specified period of time from the time the second manual switch receives the second stop operation.
Feature 48: the second specified period of time is shorter than the first specified period of time.

Feature 45 may be rephrased as applying a braking force to the motor and thereby decelerating the motor after the elapse of the first specified period of time. Feature 47 may be rephrased as applying a braking force to the motor and thereby decelerating the motor after the elapse of the second specified period of time.

The electric work machine including at least Features 1 to 18, 32 to 38, and 44 to 48 enables a degree of deceleration of the motor to be easily changed in accordance with the first actual speed.

In addition to or in lieu of at least any one of the above-described Features 1 to 48, one embodiment may include at least any one of the following Features 49 to 51.
Feature 49: the second manual switch is configured to be manually moved within a movement range, the movement range including a first region and a second region.
Feature 50: the second drive operation includes (i) moving the second manual switch to be within the first region or (ii) positioning the second manual switch within the first region.
Feature 51: the second stop operation includes (i) moving the second manual switch to be within the second region or (ii) positioning the second manual switch within the second region.

The electric work machine including at least Features 1 to 18 and 49 to 51 enables the user to easily perform the second drive operation and the second stop operation.

In addition to or in lieu of at least any one of the above-described Features 1 to 51, one embodiment may include the following Feature 52 and/or 53.
Feature 52: the drive control includes setting a desired rotational speed in accordance with a position of the second manual switch, based on the second manual switch being within the first region.
Feature 53: the drive control includes rotating the motor at the desired rotational speed that has been set.

The electric work machine including at least Features 1 to 18 and 49 to 53 enables the second manual switch to be moved within the first region and thereby easily adjust the rotational speed of the motor.

In addition to or in lieu of at least any one of the above-described Features 1 to 53, one embodiment may include the following one.
Feature 54: the drive control includes decreasing the desired rotational speed in response to the second manual switch approaching the second region, inside the first region. When the second manual switch reaches a boundary of the first region and the second region, the desired rotational speed may be set to a speed greater than or equal to zero.

In addition to or in lieu of at least any one of the above-described Features 1 to 54, one embodiment may include at least any one of the following Features 55 to 58.
Feature 55: the movement range further includes a third region.
Feature 56: the second drive operation includes (i) moving the second manual switch to be within the third region or (ii) positioning the second manual switch within the third region.
Feature 57: the drive control includes setting a desired rotational speed in accordance with a magnitude of a load being applied to the motor, based on the second manual switch being within the third region.
Feature 58: the drive control includes rotating the motor at the desired rotational speed that has been set.

The electric work machine including at least Features 1 to 18, 49 to 51, and 55 to 58 allows easy selection of different control systems (specifically, the control system corresponding to the first region and control system corresponding to the third region) using the second manual switch.

One embodiment further includes the following one.
Feature 59: the drive control includes decreasing the desired rotational speed in response to the second manual switch approaching the second region, inside the first region.

The electric work machine including at least Features 1 to 18, 32 to 38, 49 to 51, and 59 allows a decrease in the rotational speed of the motor as the user lets the second manual switch that is inside the first region approach the second region. When the second manual switch moves into the second region in a state in which the rotational speed decreases at a certain level (for example, at a speed less than the threshold speed), the motor is decelerated at a relatively greater deceleration. The user can estimate that the position where the greater deceleration starts is the boundary of the first region and the second region or is the vicinity of the boundary. Accordingly, the user can easily identify the boundary by, for example, slowly letting the second manual switch, which is inside the first region, approach the second region. After identifying the boundary, the user achieves rotation of the motor at a rotational speed as low as possible by gradually moving the second manual switch toward the first region. In other words, the electric work machine as described above is especially advantageous for users that desire to rotate the motor at a rotational speed as low as possible.

In addition to or in lieu of at least any one of the above-described Features 1 to 59, one embodiment may include the following Feature 60 and/or Feature 61.
Feature 60: the first manual switch includes a trigger.
Feature 61: the first drive operation includes moving the trigger a distance greater than or equal to a specific distance from an initial position.

One embodiment may include the following Feature 62.
Feature 62: the second manual switch includes a lever configured to be pivotally moved by the user.

The lever may be configured to allow its leading end to move along a movement path having an arc shape.

The electric work machine may include a grip configured to be gripped by a single hand of the user of the electric work machine. In this case, the first manual switch and the second manual switch may be arranged on the grip or in the vicinity of the grip. More specifically, the first manual switch and the second manual switch may be arranged to allow the user to operate the first manual switch and the second manual switch by the single hand simultaneously while gripping the grip by the single hand.

One embodiment may provide a method for controlling a motor in an electric work machine including the following Features 63 to 66.
Feature 63: stopping the motor in accordance with a first stop system (or process), based on (i) the motor being rotated and (ii) a first manual switch having received a first stop operation manually performed by a user of the electric work machine.
Feature 64: stopping the motor in accordance with a second stop system (or process), based on (i) the motor being rotated and (ii) the second manual switch receiving a second stop operation manually performed by the user.
Feature 65: the second manual switch is distinct from the first manual switch.
Feature 66: the second stop system is different from the first stop system.

The method including Features 63 to 66 enables usability when decelerating or stopping the motor to increase.

Examples of the electric work machine include various job-site electric apparatuses configured to be driven by batteries and used in job-sites, such as home carpentry, manufacturing, gardening, and construction. Specifically, examples of the electric work machine include an electric power tool for masonry work, metalworking, or woodworking, a work machine for gardening, and a device for preparing an environment of a job site. More specifically, examples of the electric work machine include an electric weed whacker (or an electric brush cutter), an electric grass cutter, an electric grass trimmer, an electric hedge trimmer, an electric hammer, an electric hammer drill, an electric drill, an electric driver, an electric wrench, an electric grinder, an electric circular saw, an electric reciprocating saw, an electric jig saw, an electric cutter, an electric chain saw, an electric planer, an electric cleaner, an electric sprayer, an electric spreader, an electric dust collector, a battery-operated wheel barrow, a battery-operated bicycle, and a fan best.

In one embodiment, the control circuit may be integrated into a single electronic unit, a single electronic device, or a single circuit board.

In one embodiment, the control circuit may be a combination of two or more electronic circuits, two or more electronic units, or two or more electronic devices individually provided on or in the electric work machine.

In one embodiment, the control circuit may include a microcomputer (or a microcontroller, or a microprocessor), a wired logic, an Application Specific Integrated Circuit (ASIC), an Application Specific Standard Product (ASSP), (for example, a field programmable gate array (FPGA) programmable logic device, a discrete electronic component and/or a programmable logic device (e.g. a Field Programmable Gate Array (FPGA)) and/or a combination thereof.

Examples of the motor include a brushless motor (or brushless DC motor), a brushed DC motor, an AC motor, and a stepper motor.

In one embodiment, the above-described Features 1 to 66 may be combined in any combination.

In one embodiment, any of the above-described Features 1 to 66 may be excluded.

### 2. Specific Example Embodiment

A specific example embodiment of the present disclosure will be described below.

### 2-1. Embodiment

### (2-1-1) Outline of Electric Work Machine

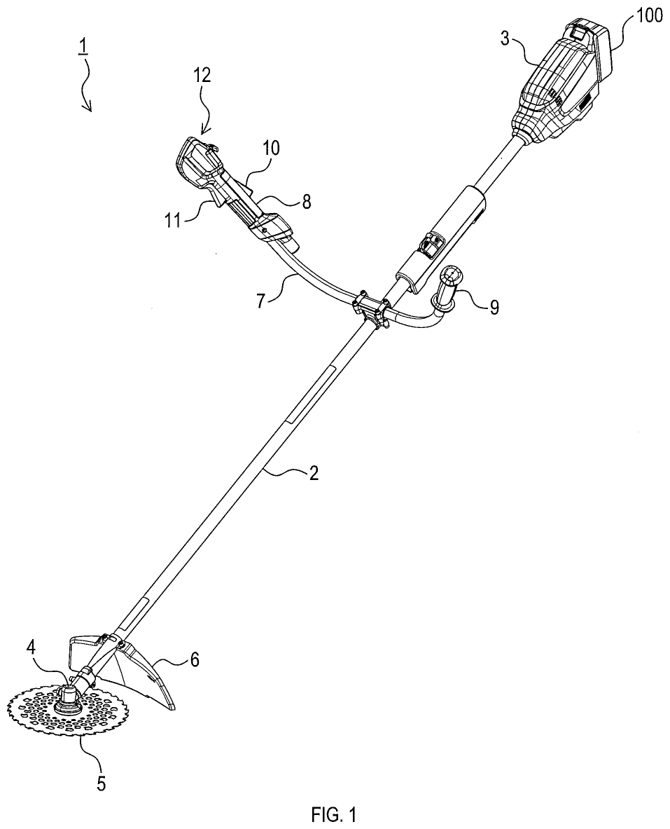

An electric work machine 1 in an embodiment shown in FIG. 1 is in the form of a brush cutter. The electric work machine 1 includes a main pipe 2. The main pipe 2 has an elongated and hollow bar-shape.

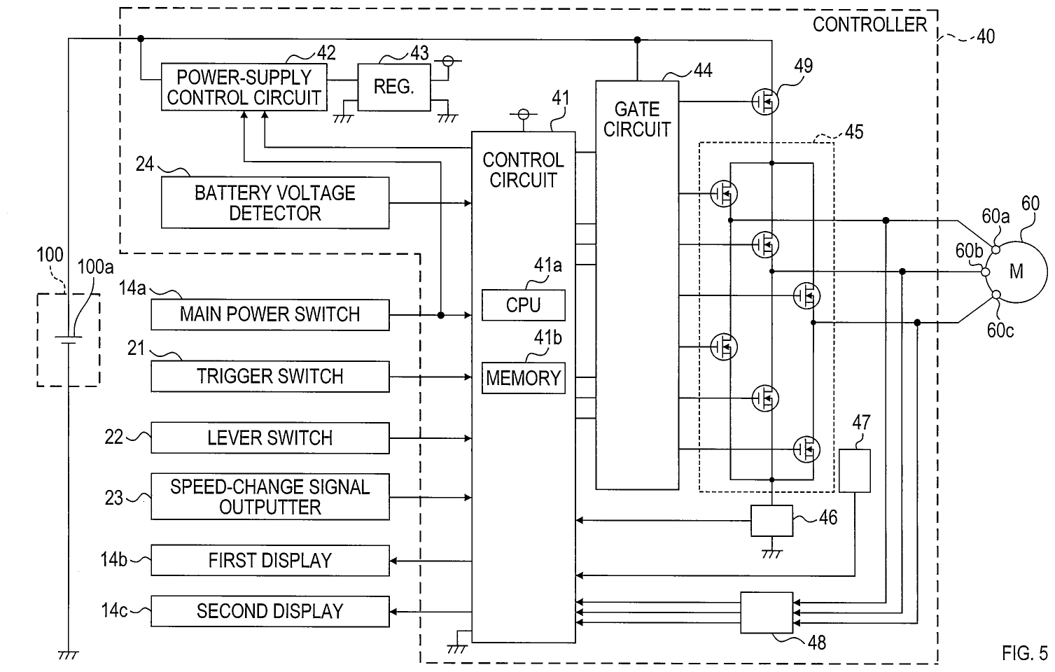

The electric work machine 1 includes a control unit 3. The control unit 3 is provided at a rear end of the main pipe 2. The control unit 3 is in the form of a hollow housing. The control unit 3 includes a battery holder in a rear end portion of the control unit 3. A battery pack 100 is detachably attached to the battery holder. The control unit 3 accommodates a controller 40 and a motor 60 (see FIG. 5), which are described below.

The battery pack 100 includes a battery 100a (see FIG. 5). The battery 100a can supply electric power (hereinafter, referred to as “battery power”) to various parts in the control unit 3. The battery 100a may be in the form of, for example, a rechargeable battery.

The electric work machine 1 includes a drive unit 4. The drive unit 4 is provided at a front end of the main pipe 2. The drive unit 4 accommodates a gear mechanism. The main pipe 2 accommodates a driving force transmission shaft (not shown). The driving force transmission shaft is coupled to the motor 60 and the gear mechanism. The driving force transmission shaft transmits a rotational force of the motor 60 (in particular, a rotor of the motor 60) to the gear mechanism.

The gear mechanism includes an output shaft (not shown). A cutting blade 5 is detachably attached to the output shaft. The cutting blade 5 is used to cut a cutting object. The cutting object includes, for example, grass and small-diameter woods. The cutting blade 5 in the present embodiment has a substantially disc-shape and includes a saw blade provided along an outer circumference of the cutting blade 5. Rotation of the motor 60 is transmitted to the output shaft via the gear mechanism. This allows the output shaft and the cutting blade 5 to rotate integrally.

The electric work machine 1 includes a cover 6. The cover 6 is provided in the vicinity of the front end of the main pipe 2. The cover 6 inhibits objects surrounding the cutting blade 5 (for example, cutting objects) from scattering toward a user of the electric work machine 1.

The electric work machine 1 includes a handle 7. The handle 7 has a U-shape. The handle 7 is coupled to the main pipe 2 in the vicinity of an intermediate position in a longitudinal direction of the main pipe 2. A first end of the handle 7 is provided with a right grip 8. A second end of the handle 7 is provided with a left grip 9. The right grip 8 is gripped by the right hand of the user. The left grip 9 is gripped with the left hand of the user.

The electric work machine 1 includes a manipulation unit (or operation unit) 12. The manipulation unit 12 is provided at a leading end of the right grip 8.

The electric work machine 1 includes a lock-off switch 10 and a first manual switch 11. In the present embodiment, the first manual switch 11 is in the form of a trigger.

The first manual switch 11 is located on a leading end part and a front part of the right grip 8. The first manual switch 11 is manually operated by the user to instruct the motor 60 to drive (i.e., rotate) or stop. The user can press the first manual switch 11 rearward (i.e., toward a side where the right grip 8 is located) by a finger (for example, an index finger) of the right hand while gripping the right grip 8 by the right hand.

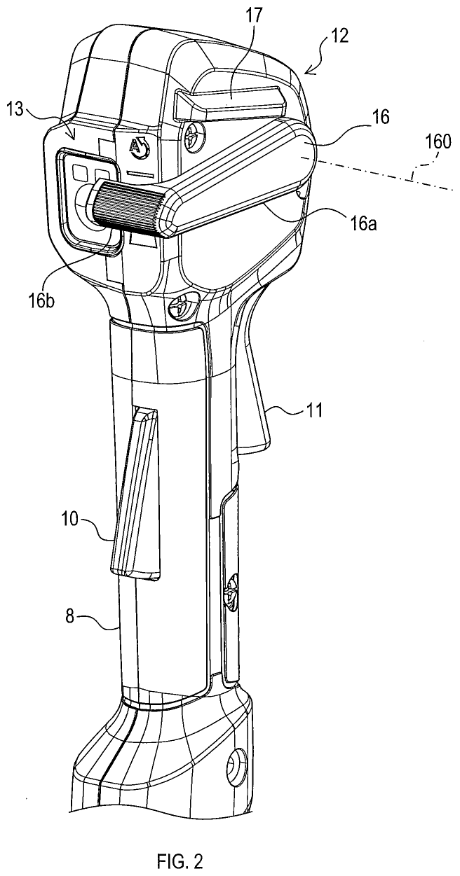

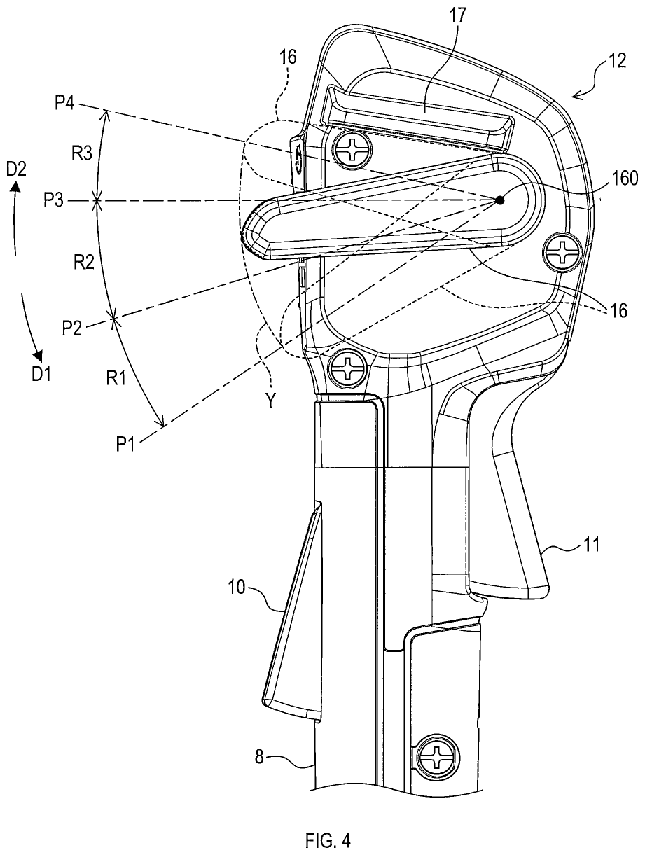

The first manual switch 11 is biased toward a front of the right grip 8 (i.e., in a direction away from the right grip 8) by a first elastic body (not shown). Accordingly, when the first manual switch 11 is not touched by the user, the first manual switch 11 is located in a first initial position. FIG. 1, FIG. 2, and FIG. 4 show the first manual switch 11 located in the first initial position.

The lock-off switch 10 is located on the leading end part and a rear part of the right grip 8. The lock-off switch 10 mechanically allows, inhibits, or prevents movement of the first manual switch 11 from the first initial position to the rear.

The lock-off switch 10 is biased toward a rear of the right grip 8 (i.e., in the direction away from the right grip 8) by a second elastic body (not shown). Accordingly, when the lock-off switch 10 is not touched by the user, the lock-off switch 10 is located in a second initial position. FIG. 1, FIG. 2, and FIG. 4 show the lock-off switch 10 located in the second initial position.

The lock-off switch 10 in the second initial position inhibits or prevents the first manual switch 11 from moving from the first initial position to the rear (i.e., being turned ON). More specifically, the lock-off switch 10 in the second initial position inhibits a trigger switch 21 (see FIG. 5) from being turned ON. The trigger switch 21 is turned ON or OFF in conjunction with the first manual switch 11. When the first manual switch 11 is located in the first initial position, the trigger switch 21 is OFF. The trigger switch 21 is accommodated in the manipulation unit 12.

When the user grips the right grip 8 by the right hand, the lock-off switch 10 can be pressed frontward (specifically, toward the right grip 8) by the right hand (i.e., for example, the palm of the hand or around the base of the thumb). Accordingly, the lock-off switch 10 is moved frontward from the second initial position against an elastic force of the second elastic body.

The lock-off switch 10 is moved frontward, thereby allowing the first manual switch 11 to move. Specifically, in a state in which the lock-off switch 10 has been moved frontward, if the first manual switch 11 is pressed, then the first manual switch 11 may be moved from the first initial position to the rear against an elastic force of the first elastic body. When the first manual switch 11 is moved a distance greater than or equal to a specific distance from the first initial position to the rear, the trigger switch 21 is turned ON. The specific distance may be zero.

### (2-1-2) Manipulation Unit

With reference to FIG. 2 to FIG. 4, a specific configuration of the manipulation unit 12 will be described.

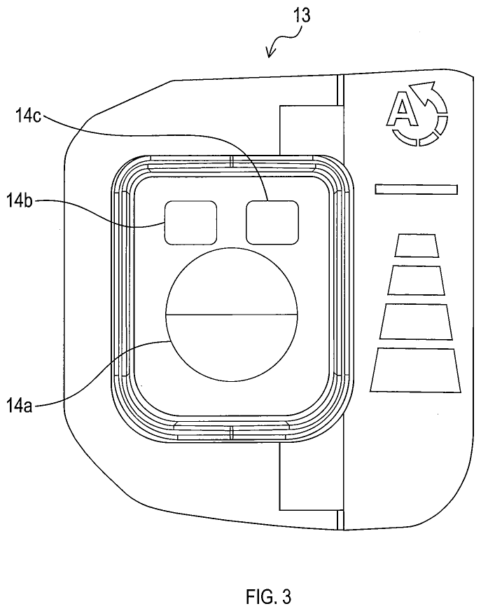

As shown in FIG. 2, the manipulation unit 12 includes an operation panel 13. As shown in FIG. 3, the operation panel 13 includes a main power switch 14a. The main power switch 14a is pressed by the user. The main power switch 14a outputs a main power signal while the main power switch 14a is being pressed. The main power switch 14a is pressed by the user to set a main power state of the electric work machine 1 (in particular, the controller 40, which will be described in detail below) to ON or OFF.

The “main power state” indicates a state of the controller 40 (see FIG. 5). Specifically, the main power state indicates a state whether the controller 40 can be operated. More specifically, the main power state indicates a state whether a described-below control circuit 41 can be operated. When the main power state is ON, various operations of the electric work machine 1 are enabled. When the main power state is OFF, the electric work machine 1 does not operate.

In the electric work machine 1 in the embodiment, each of a rotational direction and an operation mode is set. The rotational direction is set to a forward direction or a reverse direction. The operation mode is alternatively set to any one of a manual speed-change mode, a stop mode, and an automatic speed-change mode.

Furthermore, the main power switch 14a is operated by the user to set the rotational direction. In an initial state of the controller 40, the rotational direction is set to the forward direction. The initial state is a state immediately after the main power state is switched ON. While the main power state is ON, the rotational direction is alternately switched each time the main power switch 14a is pressed in a first manner. When the main power state is ON and the main power switch 14a is pressed in a second manner, the main power state is switched to OFF. When the main power state is OFF and the main power switch 14a is pressed, the main power state is switched to ON.

The first and second manners may each be any phase. In the present embodiment, the first manner includes a short press, and the second manner includes a long press. The long press means to keep pressing the switch for a specified period of time. The short press means to (i) start pressing and (ii) then release the pressing before the specified period of time elapses from starting pressing.

As shown in FIG. 3, the operation panel 13 includes a first display 14b. The first display 14b in the present embodiment includes a first LED. In a case in which the main power state is set to OFF, the first display 14b does not illuminate (i.e., the first LED does not illuminate). In a case in which the main power state is set to ON, the first display 14b illuminates.

As shown in FIG. 3, the operation panel 13 includes a second display 14c. The second display 14c in the present embodiment includes a second LED. In a case in which the operation mode is set to the automatic speed-change mode, the second display 14c illuminates (i.e., the second LED illuminates). In a case in which the rotational direction is set to the reverse direction, the first display 14b and the second display 14c blink.

As shown in FIG. 2 and FIG. 4, the manipulation unit 12 includes a second manual switch 16. In the present embodiment, the second manual switch 16 is in the form of a lever. The second manual switch 16 may be also referred to as “lever 16”. The second manual switch 16 is pivotable about a rotational axis 160. More specifically, as shown in FIG. 4, the second manual switch 16 can move (i.e., pivot) between a first position P1 and a fourth position P4 in a first direction D1 and a second direction D2. As shown in FIG. 2 and FIG. 4, the manipulation unit 12 includes a stopper 17. The second manual switch 16 comes into contact with the stopper 17 in response to reaching the fourth position P4.

As shown in FIG. 2, the second manual switch 16 includes a shaft portion 16a and a leading end portion 16b. A first end of the shaft portion 16a is fixed to a lever supporter (not shown) inside the manipulation unit 12. The leading end portion 16b is provided at a second end of the shaft portion 16a. The rotational axis 160 is a virtual axis in the vicinity of the first end of the shaft portion 16a. The shaft portion 16a extends from the rotational axis 160 in a direction perpendicular to or substantially perpendicular to the rotational axis 160.

The leading end portion 16b is touched by the user when the user moves the second manual switch 16. The user can apply a load to the leading end portion 16b in the first direction D1 or the second direction D2, for example, by the user's thumb, thereby moving the second manual switch 16.

With such a configuration, the leading end portion 16b moves along a movement path Y having an arc-shape (see FIG. 4). The movement path Y is located in an arc of a circle with a radius from the rotational axis 160 to a leading end of the second manual switch 16. The first direction D1 and the second direction D2 are along the arc. A first end of the movement path Y corresponds to the first position P1, and a second end of the movement path Y corresponds to the fourth position P4.

In response to the second manual switch 16 being pressed by the user from the first position P1 in the second direction D2, the second manual switch 16 is moved in the second direction D2. In this case, the second manual switch 16 may reach the fourth position P4, through a second position P2 and a third position P3. In response to the second manual switch 16 being pressed by the user from the fourth position P4 in the first direction D1, the second manual switch 16 is moved in the first direction D1. In this case, the second manual switch 16 may reach the first position P1, through the third position P3 and the second position P2.

The second manual switch 16 has a movement range including a first region R1, a second region R2, and a third region R3. The first region R1 defines the entire area between the first position P1 and the second position P2. The second region R2 defines the entire area between the second position P2 and the third position P3. The third region R3 defines the entire area between the third position P3 and the fourth position P4. Accordingly, when the second manual switch 16 is moved from the first region R1 to the third region R3, the second manual switch 16 passes through the second region R2. When the second manual switch 16 is moved from the third region R3 to the first region R1, the second manual switch 16 passes through the second region R2.

The manipulation unit 12 accommodates a lever switch 22 and a speed-change signal outputter 23 (see FIG. 5), which will be described below. The lever switch 22 is turned ON or OFF in accordance with a position of the second manual switch 16. The speed-change signal outputter 23 outputs a speed-change signal in accordance with the position of the second manual switch 16.

The user can manually operate the first manual switch 11 and the second manual switch 16 by the single hand (for example, right hand) simultaneously while gripping the right grip 8 with the same hand. Specifically, for example, the user can move the second manual switch 16 with the thumb while pressing the first manual switch 11 with the index finger.

### (2-1-3) Electrical Configuration

With reference to FIG. 5, an electrical configuration of the electric work machine 1 will be described. The electric work machine 1 includes the motor 60 and the controller 40. On the basis that the battery pack 100 is attached to the battery holder, the battery 100a is electrically coupled to the controller 40 as shown in FIG. 5.

In the present embodiment, the motor 60 is in the form of a brushless motor. The motor 60 includes terminals 60a, 60b, 60c. The terminals 60a, 60b, 60c are electrically coupled to the controller 40 (in particular, a below-described drive circuit 45). The motor 60 includes three windings (not shown) therein. The three windings are coupled to each other in a delta configuration or star configuration. The three windings are electrically coupled to the terminals 60a, 60b, 60c. The motor 60 receives a three-phase power from the controller 40 via the terminals 60a, 60b, 60c, and thereby is rotated.

The controller 40 includes the control circuit 41. The control circuit 41 includes a microcomputer including a CPU 41a and a memory 41b. Examples of the memory 41b include a semiconductor memory, such as a read only memory (ROM), a random access memory (RAM), a non-volatile RAM (NVRAM), and a flash memory. The control circuit 41 (in particular, CPU 41a) implements various functions by executing a program stored in the memory 41b. The control circuit 41 also causes the memory 41b to store temporary data generated in accordance with various functions.

A part or all of the various functions implemented by the control circuit 41 may be achieved by program execution (i.e., by software processing) or by one or more hardware components. For example, the control circuit 41 may include a logic circuit including two or more electronic components, instead of or in addition to a microcomputer. Also, the control circuit 41 may include, for example, an application specific IC such as an application specified integrated circuit (ASIC) and/or an application-specific standard product (ASSP), or a programmable logic device such as a field programmable gate array (FPGA), allowing configuring any logic circuit.

The controller 40 includes a power-supply control circuit 42 and a regulator 43. The power-supply control circuit 42 is electrically coupled to a positive electrode of the battery 100a to receive a direct-current (DC) battery power from the battery 100a. The power-supply control circuit 42 controls a supply of battery power to the regulator 43. Upon receipt of the battery power from the power-supply control circuit 42, the regulator 43 generates a control voltage from the battery power. The control voltage is in the form of a DC voltage. The regulator 43 supplies the control voltage to each component within the controller 40.

At the time point of attaching the battery pack 100 to the battery holder, the main power state of the controller 40 (in other words, the main power state of the control circuit 41) is OFF. That is, at this time point, the control voltage is not supplied to the control circuit 41, and the control circuit 41 is not activated.

The control circuit 41 is electrically coupled to the main power switch 14a. When the main power switch 14a is pressed after the battery pack 100 is attached to the battery holder, the main power signal is input from the main power switch 14a to the power-supply control circuit 42 and the control circuit 41. In response to receiving the main power signal, the power-supply control circuit 42 supplies the battery power to the regulator 43. Accordingly, the control voltage is supplied from the regulator 43 to the control circuit 41, and the control circuit 41 is activated.

When activated, the control circuit 41 (i) sets the main power state to ON and (ii) continuously output a power retaining signal to the power-supply control circuit 42. While the power-supply control circuit 42 is receiving the power retaining signal, a battery voltage is supplied to the regulator 43.

When the main power state is ON and the long pressed is performed on the main power switch 14a, the control circuit 41 (i) performs a necessary process to stop the own operation, and subsequently (ii) sets the main power state to OFF. When setting the main power state to OFF, the control circuit 41 stops the power retaining signal. Each time the short press is performed on the main power switch 14a when the main power state is ON, the control circuit 41 alternately switches the rotational direction.

When the input of the power retaining signal to the power-supply control circuit 42 is stopped, the power-supply control circuit 42 stops supplying the battery power to the regulator 43. Accordingly, the control voltage is not generated by the regulator 43, and an operation of the control circuit 41 is stopped. The definitions of “ON” and “OFF” for the main power state may be defined in any way as desired. For example, the “ON” of the main power state may be defined as a state in which the control voltage is supplied to the control circuit 41 and the control circuit 41 is activated. For example, the “OFF” of the main power state may be defined as a state in which the control voltage is not supplied to the control circuit 41 and the operation of the control circuit 41 is stopped.

The controller 40 includes a gate circuit 44 and a drive circuit 45. The gate circuit 44 is electrically coupled to the positive electrode of the battery 100a and receives the battery power. The drive circuit 45 is electrically coupled to the positive electrode of the battery 100a via an interruption switch 49 and receives the battery power via the interruption switch 49.

The drive circuit 45 in the present embodiment is in the form of a three-phase full-bridge circuit. Specifically, the drive circuit 45 includes three high-side switching devices and three low-side switching devices. Each switching device and the interruption switch 49 are in the form of, for example, a semiconductor switching element, more specifically, in the form of, for example, a metal oxide semiconductor field effect transistor (MOSFET).

The control circuit 41 outputs a first switch control signal and motor control signals to the gate circuit 44. The first switch control signal controls the interruption switch 49. The motor control signals control the drive circuit 45, thereby controlling the rotation of the motor 60. The motor control signals include six second switch control signals, each of which corresponds to one of the six switching devices located in the drive circuit 45. In the present embodiment, the six second switch control signals may be in the form of, for example, pulse-width modulation signals (PWM signals).

The gate circuit 44 outputs, to the interruption switch 49, a first switch drive signal based on the first switch control signal. In a case in which the first switch control signal indicates that ON of the interruption switch 49, the gate circuit 44 outputs, to the interruption switch 49, the first switch drive signal for turning ON the interruption switch 49. This causes the interruption switch 49 to be turned ON, electrically coupling the drive circuit 45 to the battery 100a via the interruption switch 49. The gate circuit 44 outputs, to the drive circuit 45, motor drive signals based on the motor control signals. The motor drive signals include six second switch drive signals. Each second switch drive signal outputs to the corresponding one of the six switching devices. The six switching devices are turned ON or OFF in accordance with the corresponding second switch drive signals. The gate circuit 44 generates the first switch drive signals, and the motor drive signals from the battery power.

When the motor 60 is being driven, the control circuit 41 turns ON the interruption switch 49 via the gate circuit 44 and drives the drive circuit 45 by the first switch control signal and the motor control signals. This causes the motor 60 to be driven.

The drive circuit 45 operates in accordance with the motor control signals from the control circuit 41 (in particular, in accordance with the motor drive signals from the gate circuit 44). In a case in which the motor control signals for driving the motor 60 are output, the drive circuit 45 generates a three-phase power in accordance with the corresponding motor control signals and supplies the three-phase power to the motor 60.

The controller 40 includes a battery voltage detector 24. The battery voltage detector 24 (i) detects a battery voltage value, and (ii) outputs, to the control circuit 41, a voltage signal indicating the battery voltage value that has been detected. The battery voltage value corresponds to a magnitude of the output voltage of the battery pack 100.

The controller 40 includes a current detection circuit 46. The current detection circuit 46 (i) detects a battery current value, and (ii) outputs, to the control circuit 41, a current signal indicating the battery current value that has been detected. The battery current value corresponds to a magnitude of the electric current supplied from the battery pack 100 to the drive circuit 45 (thus, to the motor 60).

The controller 40 includes a temperature detection circuit 47. The temperature detection circuit 47 (i) detects a circuit temperature of the controller 40, and (ii) outputs, to the control circuit 41, a temperature signal indicating the circuit temperature that has been detected.

The controller 40 includes a position detection circuit 48. The position detection circuit 48 is electrically coupled to the terminals 60a, 60b, 60c of the motor 60. The position detection circuit 48 receives first through third induced voltages from the terminals 60a, 60b, 60c. The first induced voltage is an induced voltage generated between the terminals 60a, 60b in accordance with the rotation of the motor 60. The second induced voltage is an induced voltage generated between the terminals 60b, 60c. The third induced voltage is an induced voltage generated between the terminals 60c, 60a.

The position detection circuit 48 outputs, to the control circuit 41, position detection signals based on the first through third induced voltages. Each position detection signal indicates a rotational position of the motor 60. Specifically, the position detection circuit 48 detects (i) a time point (first zero-cross point) at which the first induced voltage crosses a reference voltage value in a process of transition, (ii) a time point (second zero-cross point) at which the second induced voltage crosses a reference voltage value in a process of transition, and (iii) a time point (third zero-cross point) at which a third induced voltage crosses a reference voltage value in a process of transition. The position detection circuit 48 outputs, to the control circuit 41, the position detection signals indicating the first through third zero-cross points that have been detected.

The control circuit 41 detects a rotational position and a rotational speed of the motor 60, based on the position detection signal (i.e., based on the first through third zero-cross points). It is noted that a method of detecting the rotational position and the rotational speed based on the first through third induced voltages is known well as a core technique for a sensorless drive of a brushless motor.

The control circuit 41 rotates the motor 60 in the forward direction, based on (i) the rotational direction being set to the forward direction and (ii) a drive requirement being satisfied. When the motor 60 rotates in the forward direction, the cutting blade 5 rotates in a cutting direction. The cutting direction is a rotational direction that allows the cutting object to be cut.

On the other hand, when (i) the rotational direction is set to the reverse direction and (ii) the first manual switch 11 is turned ON, the control circuit 41 rotates the motor 60 in the reverse direction for a specified period of time. When the motor 60 rotates in the reverse direction, the cutting blade 5 rotates in an untangle direction. The untangle direction is opposite to the cutting direction. Rotation of the cutting blade 5 in the untangle direction enables the cutting object tangled around the cutting blade 5 during rotation in the cutting direction to be removed from the cutting blade 5. After rotating the motor 60 in the reverse direction for the specified period of time, the control circuit 41 sets the rotational direction to the forward direction.

The control circuit 41 is electrically coupled to the trigger switch 21. While the trigger switch 21 is ON, a first signal is input from the trigger switch 21 to the control circuit 41. The first signal indicates that the trigger switch 21 is ON (and thus, the first manual switch 11 is ON, more specifically, the first manual switch 11 is moved a distance greater than or equal to a specific distance from the first initial position).

The control circuit 41 is electrically connected to the lever switch 22 and the speed-change signal outputter 23.

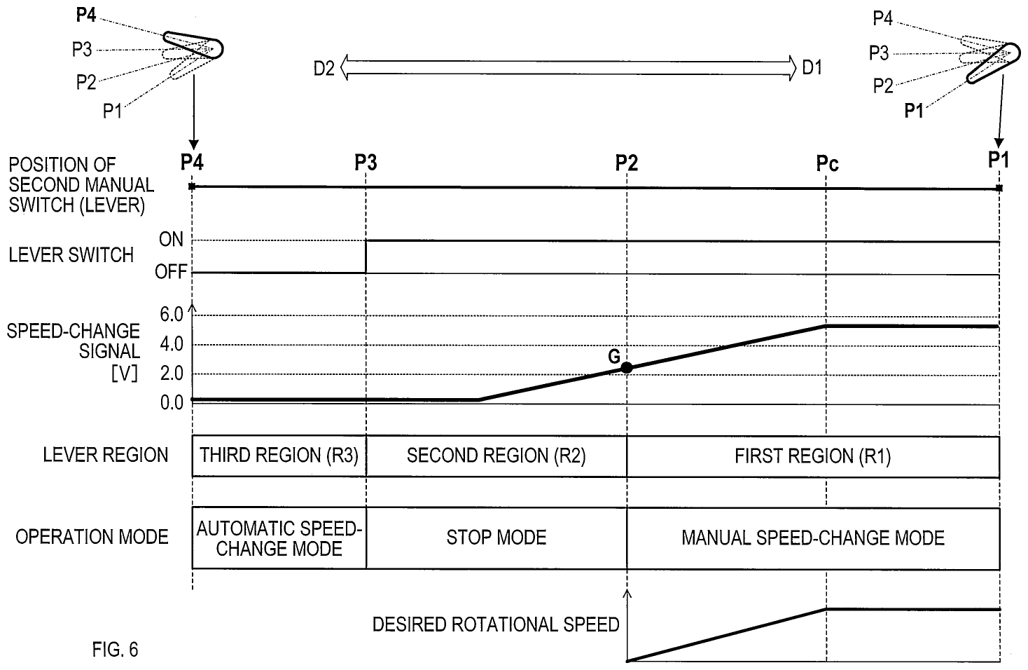

While the lever switch 22 is ON, a second signal is input from the lever switch 22 to the control circuit 41. As shown in FIG. 6, when the second manual switch 16 is within the third region R3, the lever switch 22 is turned OFF, and when the second manual switch 16 is within the first region R1 or the second region R2, the lever switch 22 is turned ON. The second signal indicates that the lever switch 22 is ON (and thus, the second manual switch 16 is within the first region R1 or the second region R2).

The speed-change signal has a voltage in accordance with the position of the second manual switch 16. As shown in FIG. 6, when the second manual switch 16 is located between a reference position and the fourth position P4, the speed-change signal has a substantially constant voltage value approximately to 0[V]. The reference position corresponds to a specific position within the second region R2. If the second manual switch 16 is moved from the reference position in the first direction D1, a voltage value of the speed-change signal (hereinafter, referred to as “speed-change signal value”) gradually increases in accordance with such a movement. Specifically, the speed-change signal value increases as a distance from the reference position increases.

In the present embodiment, when the second manual switch 16 reaches a highest speed achievement position Pc, an increase in the speed-change signal value is stopped. If the second manual switch 16 is further moved from the highest speed achievement position Pc in the first direction D1, the speed-change signal value does not change. The highest speed achievement position Pc may be set to any position within the first region R1 (other than the second position P2). Alternatively, the highest speed achievement position Pc does not have to be set. In other words, the highest speed achievement position Pc may be consistent with the first position P1. In this case, the speed-change signal value gradually increases until the second manual switch 16 is moved from the second position P2 to the first position P1.

In the present embodiment, the speed-change signal value linearly increases. However, the speed-change signal value may increase in any manner. For example, the speed-change signal value may increase in a non-linear manner. More specifically, the speed-change signal value may be, for example, in a stepwise manner.

The control circuit 41 is electrically coupled to the first display 14b and the second display 14c. The control circuit 41 individually controls, the first display 14b and the second display 14c. Specifically, as described above, the control circuit 41 individually illuminates, blinks, or turns off the first LED and the second LED in accordance with the state of the electric work machine 1.

### (2-1-4) Operation Mode

With reference to FIG. 6, the operation mode will be specifically described. The operation mode is set by the control circuit 41. In the present embodiment, in a case in which the rotational direction that has been set is the forward direction, the operation mode is set. Specifically, as shown in FIG. 6, the operation mode is set in accordance with the position of the second manual switch 16. The operation mode indicates the operation mode of the control circuit 41 (and thus, the operation mode of the controller 40 or the operation mode of the electric work machine 1).

The control circuit 41 sets the operation mode to (i) the manual speed-change mode when the second manual switch 16 is located within the first region R1, (ii) the stop mode when the second manual switch 16 is located within the second region R2, and (iii) the automatic speed-change mode when the second manual switch 16 is located within the third region R3.

In the present embodiment, the control circuit 41 determines whether the second manual switch 16 has been moved to the first region R1 (or is located within the first region R1), based on the speed-change signal value. In a case in which the speed-change signal value is less than a signal threshold, the control circuit 41 determines that the second manual switch 16 is not located within the first region R1. The signal threshold is a speed-change signal value at an operation point G shown in FIG. 6. The operation point G corresponds to a boundary of the first region R1 and the second region R2. In a case in which the speed-change signal value is greater than or equal to the signal threshold, the control circuit 41 determines that the second manual switch 16 is located within the first region R1, thereby setting the operation mode to the manual speed-change mode.

In a case in which the lever switch 22 is ON and the speed-change signal value is less than the signal threshold, the control circuit 41 determines that the second manual switch 16 is located within the second region R2, thereby setting the operation mode to the stop mode.

In a case in which the lever switch 22 is OFF, the control circuit 41 determines that the second manual switch 16 is located within the third region R3, thereby setting the operation mode to the automatic speed-change mode.

The control circuit 41 executes a drive control to rotate the motor 60 on the basis that the drive requirement is satisfied. The drive control includes rotating the motor 60 using the first switch control signal and the motor control signals. In the present embodiment, the drive requirement is satisfied on the basis that (i) the rotational direction is set to the forward direction, (ii) the trigger switch 21 is ON, and (iii) the second manual switch 16 is located within the first region R1 or the third region R3 (or, the operation mode is set to the manual speed-change mode or the automatic speed-change mode).

In a case in which the drive requirement is satisfied and the operation mode is set to the manual speed-change mode (that is, the second manual switch 16 is located within the first region R1), the control circuit 41 executes the drive control in accordance with a first control system (or a first control method), thereby rotating the motor 60. In other words, the control circuit 41 controls the drive circuit 45 using the first switch control signal and the motor control signals so that the motor 60 rotates in accordance with the first control system.

The first control system is a control system corresponding to the manual speed-change mode.

In the first control system, the motor 60 is controlled to rotate at a desired rotational speed in accordance with the position of the second manual switch 16. Specifically, in the first control system, the control circuit 41 sets the desired rotational speed based on the position of the second manual switch 16 (specifically, based on the speed-change signal value). FIG. 6 shows an example of setting the desired rotational speed in the first control system. As shown in FIG. 6, in the present embodiment, the desired rotational speed increases as the second manual switch 16 is moved from the second position P2 to the highest speed achievement position Pc. The desired rotational speed has a maximum value when the second manual switch 16 reaches the highest speed achievement position Pc. In other words, the desired rotational speed gradually decreases as the second manual switch 16 is moved from the highest speed achievement position Pc in the second direction D2 (i.e., toward the second region R2). In the present embodiment, if the second manual switch 16 is further moved from the highest speed achievement position Pc in the first direction D1, the desired rotational speed maintains at the maximum value. The desired rotational speed when the second manual switch 16 is located within the second position P2 (i.e., smallest value of the desired rotational speed) may be zero or greater than zero.

In accordance with the movement of the second manual switch 16 from the second position P2 to the first position P1, the desired rotational speed may increase. The desired rotational speed may increase in any manner. The desired rotational speed may increase, for example, linearly or non-linearly. The desired rotational speed may increase non-continuously (for example, in a stepwise manner). A section where the desired rotational speed continuously increases and a section where the desired rotational speed non-continuously increases may coexist.

The control circuit 41 detects a rotational speed (i.e., actual rotational speed) of the motor 60 based on the position detection signal from the position detection circuit 48. The control circuit 41 compares the rotational speed that has been detected with the desired rotational speed that has been set. The control circuit 41 generates and outputs the motor control signals such that the actual rotational speed is consistent with the desired rotational speed.

In the stop mode, regardless of the state of the trigger switch 21, the control circuit 41 stops the motor 60. That is, even if the trigger switch 21 is ON, the control circuit 41 stops the motor 60 in the stop mode. In a case in which the trigger switch 21 is OFF, the control circuit 41 stops the motor 60, regardless of the position of the second manual switch 16.

In a case in which the drive requirement is satisfied and the operation mode is set to the automatic speed-change mode (that is, the second manual switch 16 is located within the third region R3), the control circuit 41 executes the drive control in accordance with a second control system (or a second control method), thereby rotating the motor 60. In other words, the control circuit 41 controls the drive circuit 45 using the above-described first switch control signal and motor control signals so that the motor 60 rotates in accordance with the second control system. The second control system is a control system corresponding to the automatic speed-change mode and is different from the first control system.

In the second control system, the motor 60 is controlled to rotate at the desired rotational speed corresponding to a magnitude of a load being applied to the motor 60. Specifically, in the second control system, the control circuit 41 detects the magnitude of the load being applied to the motor 60. Herein, the load is, for example, a force applied to a rotor of the motor 60 in a direction opposite to the rotational direction of the motor 60. The load applied to the motor 60 may vary depending on conditions of the cutting operation using the cutting blade 5. In a state in which the cutting operation is not performed and the cutting blade 5 rotates idly, the load is the smallest. When the cutting blade 5 comes into contact with the cutting object to perform the cutting operation, the load increases. The magnitude of the load may be detected in any manner. The magnitude of the load may be detected, for example, based on the battery current value indicated by the current signal.

In the second control system, the control circuit 41 sets the desired rotational speed in accordance with the magnitude of the load. Specifically, in the present embodiment, the desired rotational speed increases with an increase in the load. The control circuit 41 may set the desired rotational speed in any manner in accordance with the magnitude of the load. For example, in a case in which the magnitude of the load is less than a load threshold, the control circuit 41 may set the desired rotational speed to a first speed, and in a case in which the magnitude of the load is greater than or equal to the load threshold, the control circuit 41 may set the desired rotational speed to a second speed. The second speed is greater than the first speed. In a case in which the cutting blade 5 rotates idly, the desired rotational speed that is smaller than the first speed may be set. The desired rotational speed may vary continuously or in a stepwise manner, depending on the magnitude of the load.

As described above, the control circuit 41 rotates the motor 60 in accordance with the first control system, on the basis that (i) the drive requirement is satisfied and (ii) the second manual switch 16 is located within the first region R1. If the trigger switch 21 has been turned OFF or the second manual switch 16 has been moved to the second region R2 during rotation of the motor 60 in accordance with the first control system, the control circuit 41 executes a stop control. The stop control includes stopping rotation of the motor 60.

The stop control includes a first stop control (or a control based on a first stop system) and a second stop control (or a control based on a second stop system). The second stop control is different from the first stop control. The control circuit 41 executes either the first or second stop control, thereby stopping the motor 60.

Specifically, in the embodiment, the control circuit 41 executes the first stop control to thereby stop the motor 60 on the basis that the trigger switch 21 is turned OFF. The control circuit 41 executes the second stop control to thereby stop the motor 60 on the basis that the second manual switch 16 has been moved to the second region R2.

The first stop control is different in a manner of decelerating, compared with the second stop control. Deceleration of the motor 60 is slower in the first stop control than in the second stop control.

Specifically, assume that the motor 60 is rotating at a rotational speed (for example, 2000 rpm). In this situation, if the trigger switch 21 has been turned OFF, the first stop control is executed and thereby the motor 60 decelerates and eventually stops. A mean deceleration during a period from when the trigger switch 21 is turned OFF until the motor 60 stops in this case is defined as a first mean deceleration.

On the other hand, in this situation, if the second manual switch 16 has been moved to the second region R2, the second stop control is executed, and thereby the motor 60 decelerates and eventually stops. A mean deceleration during a period from when the second manual switch 16 has been moved to the second region R2 until the motor 60 stops in this case is defined as a second mean deceleration.

In the present embodiment, the first mean deceleration is smaller than the second mean deceleration. In other words, a first stop required time is longer than a second stop required time. The first stop required time indicates a period of time from the start of the first stop control to the stop of the motor 60 in a case in which the first stop control is executed in the aforementioned situation. The second stop required time indicates a period of time from the start of the second stop control to the stop of the motor 60 in a case in which the second stop control is executed in the aforementioned situation.

The first mean deceleration may be a mean value of decelerations during a first deceleration period. The first deceleration period may be until elapse of a first deceleration time from when the trigger switch 21 is turned OFF (in other words, the first manual switch 11 is turned OFF, or the first stop control is started).

The second mean deceleration may be a mean value of decelerations during a second deceleration period. The second deceleration period may be until elapse of a second deceleration time from when the second manual switch 16 has been moved to the second region R2 (in other words, the second stop control is started).

An end timing of each of the first and second deceleration periods may be, for example, a specific timing before the motor 60 stops (that is, during rotation of the motor 60) or when the motor 60 stops. The second deceleration time may be the same as the first deceleration time.

Each of the first and the second stop controls may be executed in any method (in other words, in accordance with any control profile). In the embodiment, each the first and the second stop controls may be achieved using free running and/or braking.

Specifically, in the first stop control, the control circuit 41 lets the motor 60 to rotate by inertia (i.e., free run) until elapse of a first period of time T1 [second] (for example, 2 seconds) from when the trigger switch 21 is turned OFF. More specifically, the control circuit 41 turns OFF all the six switching devices in the drive circuit 45. After the elapse of the first period of time T1, the control circuit 41 activates the braking of the motor 60 (specifically, applies a braking force to the motor 60), thereby decelerating the motor 60. The “free run” and the “free running” mean rotation by inertia.

The braking may be executed in any method that can apply the braking force to the motor 60. The braking of the present embodiment includes a dynamic braking. The dynamic braking may be performed by electrically short-circuiting any two or more of the terminals 60a, 60b, 60c of the motor 60 to each other through the drive circuit 45.

In the second stop control, basically, the motor 60 decelerates such that the motor 60 stops earlier than in the first stop control. Such control is taken as a basis, and further, in the second stop control of the present embodiment, the motor 60 is stopped in accordance with the control profile corresponding to a first actual speed Spr.

The first actual speed Spr corresponds to an actual rotational speed of the motor 60 when the second stop control is started (in other words, the position of the second manual switch 16 is changed to the second region R2). The control profile is a control process to stop the motor 60. The control profile is executed by the control circuit 41 from the start of the second stop control to the stop of the motor 60.

In the present embodiment, the control profile is determined such that the second mean deceleration during the second deceleration period is higher as the first actual speed Spr decreases. In the following description, as an example, the end timing of the second deceleration period is determined to be the time point when the motor 60 stops.

The control profile in the present embodiment is set such that the second mean deceleration in a first case is greater than the second mean deceleration in a second case, in order to simplify the control. The first case corresponds to the first actual speed Spr being less than a threshold speed Sp1. The second case corresponds to the first actual speed Spr being greater than or equal to the threshold speed Sp1.

More specific contents of the control profile may be determined in any manner. The control profile in the present embodiment includes free running and/or braking. Specifically, in the second case, the control circuit 41 lets the motor 60 rotate by inertia until elapse of a second period of time (or specified period of time or first specified period of time) T2 from when the second stop control is started. The control circuit 41 activates the braking to thereby decelerate the motor 60 in response to the second period of time T2 elapsing. The second period of time T2 is shorter than a first period of time T1.

On the other hand, in the first case, after starting the second stop control, the control circuit 41 activates the braking without letting the motor 60 to rotate by inertia, thereby decelerating the motor 60.

Alternatively, in the first case, the control circuit 41 may let the motor 60 rotate by inertia until elapse of a third period of time (or second specified period of time) T3 from when the second stop control is started. The control circuit 41 may activate the braking in response to the third period of time T3 elapsing, thereby decelerating the motor 60. The third period of time T3 is shorter than the second period of time T2.

A first braking has a magnitude of a braking force, which may be the same as or different from that of a second braking. The first braking corresponds to the braking performed in the first stop control. The second braking corresponds to the braking performed in the second stop control.

In the present embodiment, the threshold speed Sp1 is smaller than a minimum value of a desired rotational speed that is set in the manual speed-change mode. In a case in which the second manual switch 16 is slowly moved toward the second region R2, the actual rotational speed of the motor 60 quickly follows the desired rotational speed or approximate to the desired rotational speed. In this case, the actual rotational speed when the second manual switch 16 reaches the second position P2 may be less than the threshold speed Sp1.

In a case in which the second manual switch 16 has been moved to the second region R2 when the motor 60 is driven in the automatic speed-change mode (specifically, when the second manual switch 16 is in the third region), the control circuit 41 executes the second stop control.

### (2-1-5) Process Executed by Control Circuit

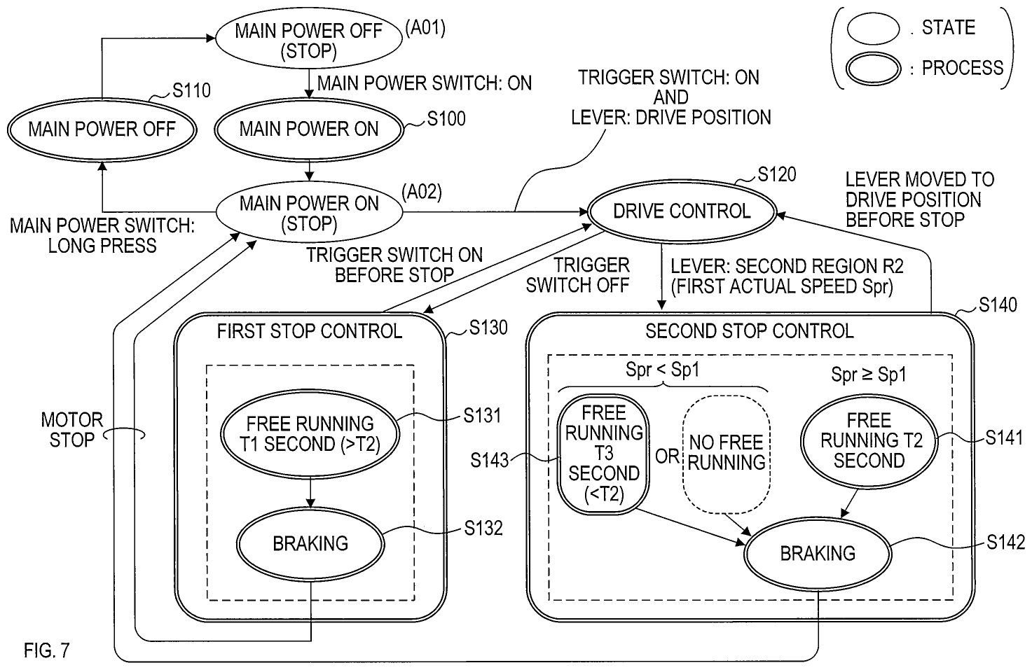

With reference to FIG. 7, processes to achieve various operations described above, which are executed by the control circuit 41 (in particular, CPU 41a), will be described. In the embodiment, programs for the processes shown in FIG. 7 are stored in, for example, the memory 41b. The control circuit 41 achieves the processes shown in FIG. 7 by executing the programs. To make the description simple and efficient, FIG. 7 describes the states of the control circuit 41 as well as the processes executed by the control circuit 41. In FIG. 7, the “lever” indicates the second manual switch 16.

In a case in which the battery pack 100 is not attached to the battery holder, the main power state of the control circuit 41 is set to OFF (state A01). At this time, the motor 60 is stopped. Also, the main power state maintains OFF immediately after the battery pack 100 is attached to the battery holder (state A01). After the battery pack 100 is attached to the battery holder, if the main power switch 14a is pressed, the control circuit 41 is activated. When activated, the control circuit 41 sets the main power state to ON (S100). Accordingly, the main power state is set to ON (state A02).

If the long press is performed on the main power switch 14a during the main power state is ON (state A02), the control circuit 41 stops the output of the power retaining signal and sets the main power state to OFF (S110). Accordingly, the main power state is set to OFF (state A01).

While the main power state is ON (state A02), if the trigger switch 21 has been turned ON and the second manual switch 16 has been moved to a drive position, the control circuit 41 executes the drive control, thereby rotating the motor 60 (S120). The drive position corresponds to the first region R1 or the third region R3.

During execution of the drive control, if the trigger switch 21 is turned OFF, the control circuit 41 executes the first stop control (S130). Specifically, the control circuit 41 lets the motor 60 free run for the first period of time T1 (S131). After the elapse of the first period of time T1, the control circuit 41 activates the braking of the motor 60 (S132). Accordingly, the motor 60 stops (state A02).

After the first stop control is started (S130), if the trigger switch 21 is turned ON before the motor 60 stops, the control circuit 41 executes the drive control and thereby rotates the motor 60 (S120).

During the execution of the drive control (S120), if the second manual switch 16 has been moved to the second region R2, the control circuit 41 executes the second stop control (S140). Specifically, the control circuit 41 acquires the actual rotational speed (specifically, the first actual speed Spr) when the second manual switch 16 is moved into the second region R2. If the first actual speed Spr is greater than or equal to the threshold speed Sp1, the control circuit 41 initially lets the motor 60 free run for the second period of time T2 (S141). After the elapse of the second period of time T2, the control circuit 41 activates the braking of the motor 60 (S142). Accordingly, the motor 60 stops (state A02).

On the other hand, if the first actual speed Spr is less than the threshold speed Sp1, the control circuit 41 brakes the motor 60 without letting the motor 60 free run (S142). Accordingly, the motor 60 stops (state A02). Alternatively, the control circuit 41 may initially let the motor 60 free run for the third period of time T3 (S143). The control circuit 41 may activate the braking in response to the third period of time T3 elapsing (S142). As described above, the third period of time T3 is shorter than the second period of time T2.

After the second stop control is started (S140), if the second manual switch 16 has been moved to the drive position before the motor 60 stops, the control circuit 41 executes the drive control to rotate the motor 60 (S120).

### (2-1-6) Correspondence Between Terms

The operation of the first manual switch 11 to turn ON the trigger switch 21 is an example of the first drive operation described in the Overview of Embodiment. In other words, moving the first manual switch 11 rearward a distance greater than or equal to a specific distance from the first initial position is an example of the first drive operation described in the Overview of Embodiment. The operation of the first manual switch 11 to turn OFF the trigger switch 21 is an example of the first stop operation described in the Overview of Embodiment. Moving the second manual switch 16 to the first region R1 or the third region R3 is an example of the second drive operation described in the Overview of Embodiment. Moving the second manual switch 16 to the second region R2 is an example of the second stop operation described in the Overview of Embodiment. The second period of time T2 is an example of the second period of time, the specified period of time, and first specified period of time, which are described in the Overview of Embodiment. The third period of time T3 is an example of the second specified period of time described in the Overview of Embodiment. The first stop control is an example of the first stop system described in the Overview of Embodiment. The second stop control is an example of the second stop system described in the Overview of Embodiment.

### 2-2. Other Embodiments

The embodiment of the present disclosure has been described so far; however, the present disclosure can be carried out in variously modified modes without being limited to the above-described embodiment.

(2-2-1) In the above-described embodiment, the first stop control includes free running and braking. However, the first stop control may be achieved in other methods. For example, the first stop control does not have to include free running. The first stop control may be configured to use only braking, thereby decelerating the motor 60. The same applies to a case in which the first actual speed Spr is greater than or equal to the threshold speed Sp1 in the second stop control. In a case in which the first actual speed Spr is less than the threshold speed Sp1 in the second stop control, free running and braking may be used. The first stop control does not have to include braking. The first stop control may use only free running and thereby decelerate the motor 60.

(2-2-2) In the second stop control in the above-described embodiment, the control profile is switched based on the threshold speed Sp1 as a reference. However, the control profile may be switched in any manner in accordance with the first actual speed Spr. For example, two or more threshold speeds may be set. Based on comparing the first actual speed Spr with two or more threshold speeds, a level of the first actual speed Spr may be determined. Of two or more control profiles, the control profile corresponding to the determined level may be used. The two or more control profiles may be set such that the second mean deceleration becomes smaller as the level of the first actual speed Spr is higher.

(2-2-3) The first region R1 (manual speed-change mode), the second region R2 (stop mode), and the third region R3 (automatic speed-change mode) may be set to any location in the movement path Y.

In the present embodiment, the first region R1, the second region R2, and the third region R3 are aligned in order along the second direction D2. However, for example, the first region R1, the second region R2, and the third region R3 may be aligned in order along the first direction D1. That is, the operation mode may be switched to the automatic speed-change mode by movement of the second manual switch 16 from the second region R2 in the first direction D1, and the operation mode may be switched to the manual speed-change mode by movement of the second manual switch 16 from the second region R2 in the second direction D2.

Further, for example, the first region R1 and the third region R3 may be adjacent to each other. That is, without passing through the second region R2, the second manual switch 16 may be moved from the first region R1 to the third region R3 and from the third region R3 to the first region R1.

(2-2-4) In the automatic speed-change mode, the desired rotational speed may be set in any manner in accordance with the load. For example, contrary to the above-described embodiments, the desired rotational speed may decrease as the load increases. Specifically, for example, in a case in which the magnitude of the load is less than the load threshold, the desired rotational speed is set to the second speed, and in a case in which the magnitude of the load is greater than or equal to the load threshold, the desired rotational speed may be set to the first speed. The first speed is smaller than the second speed.

(2-2-5) The second manual switch 16 and the first manual switch 11 may be provided to the left grip 9 or in the vicinity of the left grip 9. Alternatively, each of the second manual switch 16 and the first manual switch 11 may be provided to a corresponding one of grips.

(2-2-6) The second manual switch 16 may be provided in any form. The movement path Y of the second manual switch 16 may be set in any manner. The second manual switch 16 may be in a form different from a lever. The second manual switch 16 may be in the form of, for example, a sliding witch, a dial, and the like.

The second manual switch of the present disclosure may be provided in any form and any location in the manipulation unit 12. The second manual switch may be provided, for example, on a surface where the operation panel 13 is located. The second manual switch may be moved in any direction, any manner, and/or any area.

(2-2-7) The motor 60 may be provided outside the control unit 3. The motor 60 may be accommodated in, for example, the drive unit 4.

(2-2-8) Two or more functions of a single element in the above-described embodiments may be performed by two or more elements, and a single function of a single element may be performed by two or more elements. Two or more functions performed by two or more elements may be performed by a single element, and a single function performed by two or more elements may be performed by a single element. Part of the configuration in the above-described embodiments may be omitted. At least a part of the configuration in the above-described embodiments may be added to or replace another configuration in the above-described embodiments.

What is claimed is:

1. An electric work machine, comprising:
a motor;
a first manual switch configured to alternatively receive a first drive operation or a first stop operation, the first drive operation and the first stop operation being manually performed by a user of the electric work machine;
a second manual switch configured to alternatively receive a second drive operation or a second stop operation, the second drive operation and the second stop operation being manually performed by the user; and
a control circuit configured to execute:
a drive control to rotate the motor, based on (i) the first manual switch receiving the first drive operation and (ii) the second manual switch receiving the second drive operation,
a first stop control to stop the motor, based on (i) the motor being rotated and (ii) the first manual switch having received the first stop operation, and
a second stop control to stop the motor, based on (i) the motor being rotated and (ii) the second manual switch having received the second stop operation, the second stop control being different from the first stop control.

2. The electric work machine according to claim 1, wherein
the first stop control includes decelerating the motor at a first mean deceleration and thereby stopping the motor, based on (i) the motor being rotated and (ii) the first manual switch having received the first stop operation, the first mean deceleration being a mean value of decelerations of the motor during a period from a time the first manual switch receives the first stop operation until the motor stops, and
the second stop control includes decelerating the motor at a second mean deceleration and thereby stopping the motor, based on (i) the motor being rotated and (ii) the second manual switch having received the second stop operation, the second mean deceleration being (i) a mean value of decelerations of the motor during a period from a time the second manual switch receives the second stop operation until the motor stops and (ii) different from the first mean deceleration.

3. The electric work machine according to claim 2, wherein
the first mean deceleration is smaller than the second mean deceleration.

4. The electric work machine according to claim 1, wherein
the first stop control includes:
rotating the motor by inertia until elapse of a first period of time from a time the first manual switch receives the first stop operation; and
applying a braking force to the motor and thereby decelerating the motor, based on the elapse of the first period of time from the time the first manual switch receives the first stop operation, and
the second stop control includes:
rotating the motor by inertia until elapse of a second period of time from a time the second manual switch receives the second stop operation, the second period of time being shorter than the first period of time, and
applying a braking force to the motor and thereby decelerating the motor, based on the elapse of the second period of time from the time the second manual switch receives the second stop operation.

5. The electric work machine according to claim 1, wherein
the second stop control includes stopping the motor in accordance with a control profile, the control profile being based on a first actual speed, the first actual speed being an actual rotational speed of the motor at a time the second manual switch receives the second stop operation.

6. The electric work machine according to claim 5, wherein
the control profile is configured such that a second mean deceleration in a first state is greater than the second mean deceleration in a second state,
the second mean deceleration is a mean value of decelerations of the motor during a period from the time the second manual switch receives the second stop operation until the motor stops, and
the first state corresponds to a state in which the first actual speed is less than a threshold speed, and the second state corresponds to a state in which the first actual speed is greater than or equal to the threshold speed.

7. The electric work machine according to claim 6, wherein
the control profile includes:
rotating the motor by inertia until elapse of a specified period of time from the time the second manual switch receives the second stop operation, based on the first actual speed being greater than or equal to the threshold speed,
applying a braking force to the motor and thereby decelerating the motor, based on (i) the first actual speed being greater than or equal to the threshold speed and (ii) the elapse of the specified period of time from the time the second manual switch receives the second stop operation, and
applying a braking force to the motor without rotating the motor by inertia and thereby decelerating the motor, based on the first actual speed being less than the threshold speed.

8. The electric work machine according to claim 6, wherein
the control profile includes:
rotating the motor by inertia until elapse of a first specified period of time from the time the second manual switch receives the second stop operation, based on the first actual speed being greater than or equal to the threshold speed,
applying a braking force to the motor and thereby decelerating the motor, based on (i) the first actual speed being greater than or equal to the threshold speed and (ii) the elapse of the first specified period of time from the time the second manual switch receives the second stop operation,
rotating the motor by inertia until elapse of a second specified period of time from the time the second manual switch receives the second stop operation, based on the first actual speed being less than the threshold speed, the second specified period of time being shorter than the first specified period of time, and
applying a braking force to the motor and thereby decelerating the motor, based on (i) the first actual speed being less than the threshold speed and (ii) the elapse of the second specified period of time from the time the second manual switch receives the second stop operation.

9. The electric work machine according to claim 1, wherein
the second manual switch is configured to be manually moved within a movement range, the movement range including a first region and a second region,
the second drive operation includes moving the second manual switch to be within the first region or positioning the second manual switch within the first region, and
the second stop operation includes moving the second manual switch to be within the second region or positioning the second manual switch within the second region.

10. The electric work machine according to claim 9, wherein
the drive control includes:
setting a desired rotational speed in accordance with a position of the second manual switch, based on the second manual switch being within the first region, and
rotating the motor at the desired rotational speed that has been set.

11. The electric work machine according to claim 10, wherein
the drive control includes decreasing the desired rotational speed in response to the second manual switch approaching the second region, inside the first region.

12. The electric work machine according to claim 9, wherein
the movement range further includes a third region,
the second drive operation includes moving the second manual switch to be within the third region or positioning the second manual switch within the third region, and
the drive control includes:
setting a desired rotational speed in accordance with a magnitude of a load being applied to the motor, based on the second manual switch being within the third region, and
rotating the motor at the desired rotational speed that has been set.

13. The electric work machine according to claim 6, wherein
the second manual switch is configured to be manually moved within a movement range, the movement range including a first region and a second region,
the second drive operation includes moving the second manual switch to be within the first region or positioning the second manual switch within the first region,
the second stop operation includes moving the second manual switch to be within the second region or positioning the second manual switch within the second region, and
the drive control includes:
setting a desired rotational speed, based on the second manual switch being within the first region, setting the desired rotational speed including decreasing the desired rotational speed in response to the second manual switch approaching the second region, and
rotating the motor at the desired rotational speed that has been set.

14. The electric work machine according to claim 1, wherein
the first manual switch includes a trigger, and
the first drive operation includes moving the trigger a distance greater than or equal to a specific distance from an initial position.

15. The electric work machine according to claim 1, wherein
the second manual switch includes a lever configured to be pivotally moved by the user.

16. A method for controlling a motor in an electric work machine, the method comprising:
stopping the motor in accordance with a first stop system, based on (i) the motor being rotated and (ii) a first manual switch having received a first stop operation manually performed by a user of the electric work machine, and
stopping the motor in accordance with a second stop system, based on (i) the motor being rotated and (ii) the second manual switch receiving a second stop operation manually performed by the user, the second manual switch being distinct from the first manual switch, the second stop system being different from the first stop system.
